(19) United States
(12) Patent Application Publication
(10) Pub. No.: US 2011/0017074 A1
(43) Pub. Date: Jan. 27, 2011

(54) DRINKS MACHINE

(76) Inventor: Frank Göltenboth, Blaustein (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/840,507

(22) Filed: Jul. 21, 2010

(30) Foreign Application Priority Data
Jul. 23, 2009 (DE) 102009034234.6

(51) Int. Cl. A01J 11/04

(52) U.S. Cl. 99/323.1

(57) ABSTRACT

A drink machine for producing at least one of a frothy milk and a heated milk. The drink machine has at least one of a milk supply duct and a steam supply duct, wherein at least one of the ducts opens into at least one of a mixing region and a frothing region; a line element connected at one end in the region of a coupling point in fluid communication with the milk supply duct and at the other end to a container for milk; and a rinsing line, which opens directly into the coupling point.

The present invention relates to a drinks machine with a means for producing frothy milk and/or heated milk according to the preamble of Claim 1.

A generic drinks machine is known for example from WO 2005/102126 A2. In the known drinks machine, in order to produce frothy milk, a milk container is coupled to the drinks machine and milk is sucked out of the milk container by ejecting steam. In this case frothy milk is output separately from coffee and in particular not at the same time as the latter.

EP 1 688 074 B1 discloses an arrangement for producing frothy milk and for producing milk with a frothing device which is provided with a steam supply duct, an air inlet, a milk supply duct and a discharge opening. Rapid draining of milk which is still contained in the frothing device after the frothy milk is produced and/or the milk is heated is to be achieved by the provision of a ventilation duct by means of which the frothing device can be ventilated after frothy milk has been produced or milk has been heated and a valve arrangement by means of which the ventilation duct and/or the air inlet duct can be closed as a function of the desired operating mode.

Finally, DE 44 45 436 C2 discloses a frothing device for frothing milk with a feed line for steam, a feed line for air and a feed line for milk, as well as a mixing region in which the feed lines are brought together. The feed line for the air is connected to a source of compressed air for blowing in the air, with it being possible to control this blowing in of air. The frothing characteristics are in particular to be improved thereby.

The present invention is concerned with the problem of specifying an improved embodiment for a drinks machine of the generic type, which provides a simplified method for rinsing and thus ensuring operating hygiene.

This problem is solved according to the invention by the subject matter of the independent claim. Advantageous embodiments form the subject matter of the dependent claims.

The invention is based on the general idea of providing a line element in a drinks machine with a means for producing frothy milk and/or heated milk, which line element can be connected at one end in the region of a coupling point in a communicating manner to a milk supply duct which is arranged in the drinks machine and at the other end to a container for milk. Furthermore, a rinsing line is provided which opens directly into the coupling point, so that at least all the line parts which come into contact with milk outside the container for milk, namely the coupling point, the milk supply duct and the means can be rinsed. The rinsing line which opens into the coupling element has the task of rinsing all the parts which come into contact with milk downstream of the coupling point as required or at the request of the customer. The drinks machine according to the invention thus has the great advantage compared to those known from the prior art that frothy milk and coffee are output at the same point, with it being possible for the frothy milk and the coffee to be prepared at the same time. The container for the milk can be configured either externally, for example in the form of a milk drinks carton, or else form a component which can be inserted into the drinks machine. In the drinks machine according to the invention, the line element is thus only connected to the milk supply duct via the coupling point and thereby makes it possible to suck the milk out of the milk container. The line element can be an integral component of the milk container or its lid and does not have to be configured as a hose (as in most of the prior art). This allows a relatively large cross section which can also be cleaned effectively in a dishwasher.

In an advantageous development of the solution according to the invention, the line element has a valve for preventing backflow of rinsing medium into the container. This valve can for example be arranged in the region of the coupling point between the line element and the milk supply duct and is preferably configured in such a manner that the valve closes automatically as soon as the line element is removed from the coupling point. The valve can either be controllable or merely switchable between two states, with one switched state being the closed state of the valve and the other switched state being the open state of the valve. The last two switched states can for example be effected by simply inserting the line element into the milk supply duct or pulling the line element out of the milk supply duct. A very simple possibility of keeping the milk system hygienically clean is provided by this arrangement: The milk container together with the suction line can be cleaned in a dishwasher after being disconnected from the drinks machine, the milk system remaining on the machine can be cleaned automatically and hygienically by means of the rinsing line.

The milk supply duct is expediently part of the preferably removable means for producing frothy milk and/or heated milk. In this case it is thus possible to remove from the drinks machine and for example to clean not only the milk supply duct but also, at the same time as the latter, the means for producing frothy milk. Of course, the milk supply duct in the drinks machine according to the invention runs at least partially inside the latter.

Further important features and advantages of the invention can be found in the subclaims, the drawings and the associated description of the figures using the drawings.

It is self-evident that the features which are mentioned above and those which are still to be explained below can be used not only in the combination specified in each case, but also in other combinations or alone without departing from the framework of the present invention.

Preferred exemplary embodiments of the invention are shown in the drawings and are explained in more detail in the following description, with the same reference symbols referring to the same or similar or functionally identical components.

In the figures,

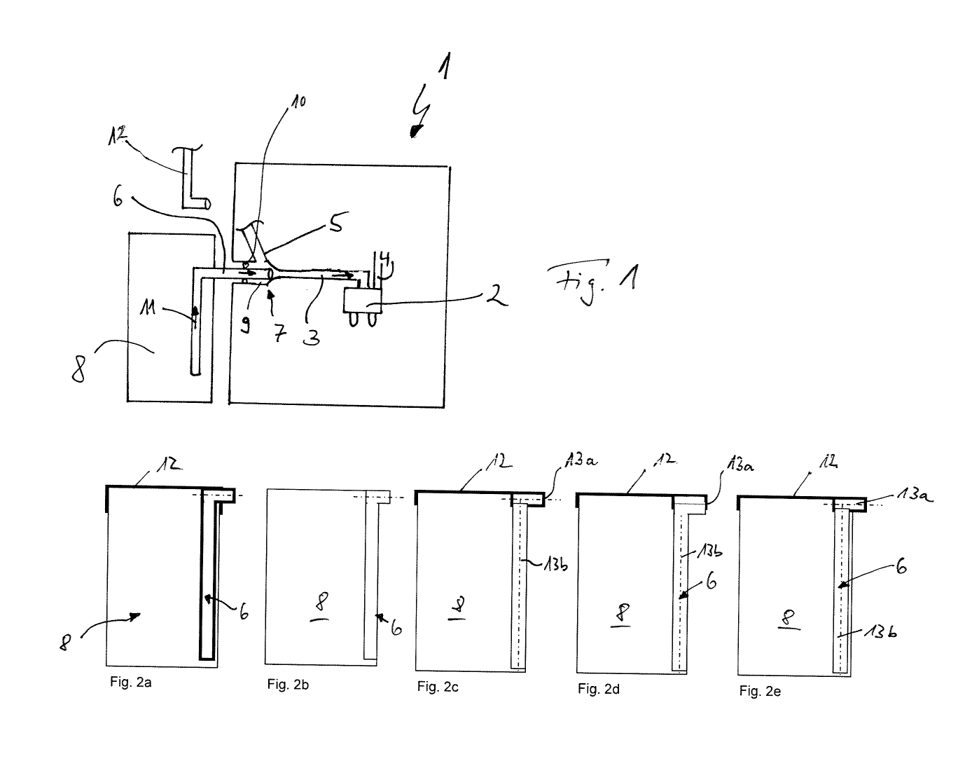

FIG. 1 schematically shows a drinks machine according to the invention with a means for producing frothy milk,

FIG. 2a-e in each case schematically show a milk container according to FIG. 1 with a line element connected to it.

According to FIG. 1, a drinks machine 1 according to the invention has a means 2 for producing frothy milk and/or heated milk. The means 2 is connected in a communicating manner to a milk supply duct 3 and a steam supply duct 4, and via the milk supply duct 3 to a rinsing medium duct 5, also referred to below as rinsing line 5. Both the milk supply duct 3 and the steam supply duct 4 open into a mixing/frothing region of the means 2. According to the invention a line element 6 is provided which can be connected at one end in the region of a coupling point 7 in a communicating manner to the milk supply duct 3 and at the other end to a container 8 for milk. A Venturi geometry 9 can also be provided in the region of the coupling point 7.

A valve 10 can be provided in particular in the region of the coupling point 7, that is, in the region of a free end of the line element 6, which valve is configured as a non-return valve and at least makes a backflow of milk into the container 8 difficult. The valve 10 can be configured in such a manner that it makes it possible to rinse the regions which lie downstream and comes into contact with milk when in the closed state, while also allowing the line element 6 which lies upstream of the valve 10 to be rinsed when in the open state. The flow direction which prevails during normal operation within the line element 6 is shown with flow arrows 11. Of course, the valve 10 can also close automatically just when the line element 6 is removed from the drinks machine 1. It is likewise conceivable for the valve 10 to be configured as a duckbill valve, as a sealing ring or as another type of sealing element.

A particular advantage of the drinks machine 1 according to the invention is that the container 8 together with the line element 6 can be removed and cleaned separately, for example in a dishwasher. The parts which are situated in the drinks machine 1 itself and come into contact with milk, such as the means 2 and the milk supply duct 3, can in contrast be cleaned easily by means of the rinsing line 5. The cross section which is used in particular for the line element 6 is furthermore large enough for the latter to be easily accessible for cleaning in a dishwasher. Of course, it is also conceivable for an external rinsing line 12 to be connected to the drinks machine 1 for cleaning the means 2 and the milk supply duct 3.

FIGS. 2a to 2e show various possible embodiments of the container 8 and the associated line element 6. In the container 8 according to FIG. 2a, the line element 6 is part of a container lid 12, that is, can be removed and cleaned together with the latter. In the container 8 according to FIG. 2b, the line element 6 is part of the container 8 itself.

In the container 8 according to FIGS. 2c and 2d, the line element 6 is constructed in two parts. In each case, one part 13a of the line element 6 is part of the container lid 12 and the other part 13b of the line element 6 is part of the container 8, with it being possible to couple both parts 13a and 13b of the line element 6 to each other in a leakproof manner.

In the container 8 according to FIG. 2e, the line element 6 is likewise constructed in two parts, with it being part of the container lid 12. At the same time however at least the part 13b of the line element 6 can be removed from the container lid 12 and cleaned separately from the latter.

1. A drink machine for producing at least one of a frothy milk and a heated milk, comprising:
at least one of a milk supply duct and a steam supply duct, wherein at least one of the ducts opens into at least one of a mixing region and a frothing region;
a line element connected at one end in the region of a coupling point in fluid communication with the milk supply duct and at the other end to a container for a supply of milk; and
a rinsing line, which opens directly into the coupling point.

2. The drink machine according to claim 1, further comprising a valve in fluid communication with at least one of the line element and the coupling point, wherein the valve prevents a backflow of rinsing medium into at least one of the container, the line element and from exiting from the coupling point in the absence of the line element.

3. The drink machine according to claim 2, wherein the valve is configured such that it rinses at least one of the a downstream region and an upstream region when the valve is at least one of opened and closed.

4. The drink machine according to claim 1, wherein a Venturi geometry is configured between an opening of the rinsing line into the coupling element, and wherein the Venturi geometry is dimensioned to prohibit at least one of a flow back of water into the line element and a sucking out of milk during the rinsing process.

5. The drink machine according to claim 2, wherein the valve closes automatically when the line element is removed.

6. The drink machine according to claim 2, wherein the valve is configured as a duckbill valve.

7. The drink machine according to claim 1, further comprising: a detector, which detects whether the line element is at least one of uncoupled and coupled.

8. The drink machine according to claim 1, wherein the drink machine is configured to automatically trigger a rinsing operation when the line element is detached.

9. The drink machine according to claim 1, wherein the machine for producing the at least one of the frothy milk and the heated milk is removable.

10. The drink machine according to claim 1, wherein the line element is part of the container for milk and is designed such that it is cleaned together with the container in a dishwasher.

11. The drink machine according to claim 9, wherein the milk supply duct is part of the removable machine for producing at least one of the frothy milk and heated milk.

12. The drink machine according to claim 2, wherein a Venturi geometry is configured between an opening of the rinsing line into the coupling element, and wherein the Venturi geometry is dimensioned to prohibit at least one of a flow back of water into the line element and a sucking out of milk during the rinsing process.

13. The drink machine according to claim 3, wherein a Venturi geometry is configured between an opening of the rinsing line into the coupling element, and wherein the Venturi geometry is dimensioned to prohibit at least one of a flow back of water into the line element and a sucking out of milk during the rinsing process.

14. The drink machine according to claim 3, wherein the valve at least one of closes automatically when the line element is removed and is configured as a duckbill valve.

15. The drink machine according to claim 4, wherein the valve at least one of closes automatically when the line element is removed and is configured as a duckbill valve.

16. The drink machine according to claim 2, further comprising: a detector, which detects whether the line element is at least one of uncoupled and coupled, and wherein drink machine is configured to automatically trigger a rinsing operation when the line element is detached.

17. The drink machine according to claim 3, further comprising: a detector, which detects whether the line element is at least one of uncoupled and coupled, and wherein drink machine is configured to automatically trigger a rinsing operation when the line element is detached.

18. The drink machine according to claim 4, further comprising: a detector, which detects whether the line element is at least one of uncoupled and coupled, and wherein drink machine is configured to automatically trigger a rinsing operation when the line element is detached.

19. The drink machine according to claim 5, further comprising: a detector, which detects whether the line element is at least one of uncoupled and coupled, and wherein drink machine is configured to automatically trigger a rinsing operation when the line element is detached.

20. The drink machine according to claim 6, further comprising: a detector, which detects whether the line element is at least one of uncoupled and coupled, and wherein drink machine is configured to automatically trigger a rinsing operation when the line element is detached.
